(19) United States
(12) Patent Application Publication
(10) Pub. No.: US 2010/0002637 A1
(43) Pub. Date: Jan. 7, 2010

(54) Resource Allocation in Wireless Communications System

(75) Inventors: Rauno Huoviala, Helsinki (FI); Niclas Svahnström, Helsinki (FI)

Correspondence Address: COHEN, PONTANI, LIEBERMAN & PAVANE LLP, 551 FIFTH AVENUE, SUITE 1210, NEW YORK, NY, 10176, US

(73) Assignee: TeliaSonera AB, Stockholm (SE)

(21) Appl. No.: 12/311,074

(22) PCT Filed: Sep. 27, 2007
(86) PCT No.: PCT/FI2007/050522

§ 371 Date: Apr. 9, 2009

(30) Foreign Application Priority Data
Sep. 28, 2006 (FI) 20065605

(51) Int. Cl. H04W 72/04

(52) U.S. Cl. 370/329

(57) ABSTRACT

Wireless links used as backhauls for wireless access networks may be provided by an HSDPA, while hot spots for network access may be built using another radio technology, such as WLAN. There may be several end-user terminals simultaneously accessing the network through the hot spot. Information on the number of user terminals connected to a hot spot is found out, and the information is provided to a backhaul network. The backhaul network then allocates the backhaul network resources between the user terminals connected to the hot spot and the user terminals connected to the backhaul network such that the number of user terminals connected to the hot spot is taken into account.

### FIELD OF THE INVENTION

The present invention relates to a method of allocating backhaul network resources to user terminals by utilizing access points of another network, such as a WLAN (Wireless Local Area Network).

### BACKGROUND OF THE INVENTION

Wireless links are used as backhauls for wireless access networks e.g. in rural areas where it is expensive to build wired links. A backhaul link may be provided by means of a radio access network using a selected radio network technology, such as HSDPA (High-speed Downlink Packet Access), WiMAX (Worldwide Interoperability for Microwave Access) or flash-OFDM, while hot spots for network access may be built using another radio technology, such as WLAN. In wireless LAN technology, user terminals are provided with wireless LAN connections in order to access, for instance, the Internet through wireless LAN access points which are mainly located in “hot spots”. The backhaul network technologies usually allocate their radio resources to end-users in time division and round robin manner.

A problem associated with the above arrangement is that when allocating resources, the network providing the backhaul link logically treats the access point located in the hot spot network as one end-user. This means that if several end-users are simultaneously accessing the network through the hot spot, they have to share an amount of resources that corresponds to an amount of resources the backhaul network would provide to a single end-user. At the same time, an end-user directly accessing the backhaul network receives an amount of resources equal to that received by the hot spot end-users altogether.

### BRIEF DESCRIPTION OF THE INVENTION

An object of the present invention is thus to provide a method, a communications system and an access point for implementing the method so as to alleviate the above problem. The objects of the invention are achieved by a method and an arrangement which are characterized by what is stated in the independent claims. Embodiments of the invention are disclosed in the dependent claims.

The invention is based on the idea that information on the number of user terminals connected to a hot spot is found out, and the information is provided to a backhaul network. The backhaul network then allocates the backhaul network resources between the user terminals connected to the hot spot and the user terminals connected directly to the backhaul network such that the number of user terminals connected to the hot spot is taken into account.

An advantage of the method and arrangement of the invention is that the network resources can be divided evenly and/or according to operator needs between users directly connected to the backhaul network and users connected to the backhaul network via another wireless network. Thus the allocation of the network resources can be controlled by the operator both in the access network providing the hot spots as well as in the access network providing the backhaul.

### BRIEF DESCRIPTION OF THE DRAWINGS

In the following, the invention will be described in greater detail by means of embodiments with reference to the accompanying drawings, in which

FIG. 1 illustrates a communications system according to the present invention;

FIG. 2 is a signalling chart illustrating a method according to the present invention;

FIG. 3 is a flow chart illustrating how an access point of a wireless access network according to the present invention functions;

FIG. 4 is a flow chart illustrating how an access point of a backhaul network according to the present invention functions;

FIG. 5 illustrates prioritisation according to an embodiment of the present invention;

FIG. 6 illustrates a mesh network according to an embodiment of the present invention.

### DETAILED DESCRIPTION OF THE INVENTION

In the following, preferred embodiments of the invention will be described with reference to a wireless communications system, such as UMTS (Universal Mobile Telecommunications System), WCDMA (Wideband Code Division Multiple Access), HSDPA, WiMAX, OFDM or WLAN. This invention is not, however, meant to be restricted to these embodiments. Consequently, the invention may be applied to any wireless or mobile communications system capable of providing a packet switched radio service. Especially the specifications of 3rd generation (3G) mobile communications systems advance rapidly. This may require additional changes to the invention. For this reason, the terminology and the expressions used should be interpreted in their broadest sense since they are meant to illustrate the invention and not to restrict it. The relevant inventive aspect is the functionality concerned, not the network element or equipment where it is executed.

HSDPA is a feature of the WCDMA, providing high data rate trans-mission on the downlink to support multimedia services. HSDPA provides 3G terminals with high-speed data delivery, ensuring that users requiring effective multimedia capabilities benefit from data rates previously unavailable because of limitations in the radio access network RAN.

WiMAX has been defined by the WiMAX Forum to promote conformance and interoperability of the WLAN standard. The WiMAX refers to a wireless technology that provides high-throughput broadband connections over long distances. It can be used for a number of applications, including “last mile” broadband connections, hotspots and cellular backhaul, and high-speed enterprise connectivity for business. The WiMAX provides increased bandwidth and stronger encryption. It makes use of multi-path signals, and enables connectivity to be provided between network endpoints without direct line of sight. The use of WiMAX for “last mile” connectivity may result in better price-points in both business and home applications, and WiMAX enables broadband access in areas with no existing physical cable or telephone networks.

OFDM is an FDM (Frequency Division Multiplexing) modulation technique for transmitting large amounts of digital data over a radio wave. OFDM operates by splitting a radio signal into multiple smaller sub-signals that are then transmitted simultaneously to the receiver at different frequencies. OFDM enables the amount of disturbance to be reduced in signal transmissions.

Flash-OFDM is a signal processing scheme that supports high data rates at very low packet and delay losses, also known as latencies, over a distributed all-IP wireless network. Such low-latency enables real-time mobile interactive and multimedia applications. It delivers a higher quality wireless service and improves the cost effectiveness of the wireless data technologies.

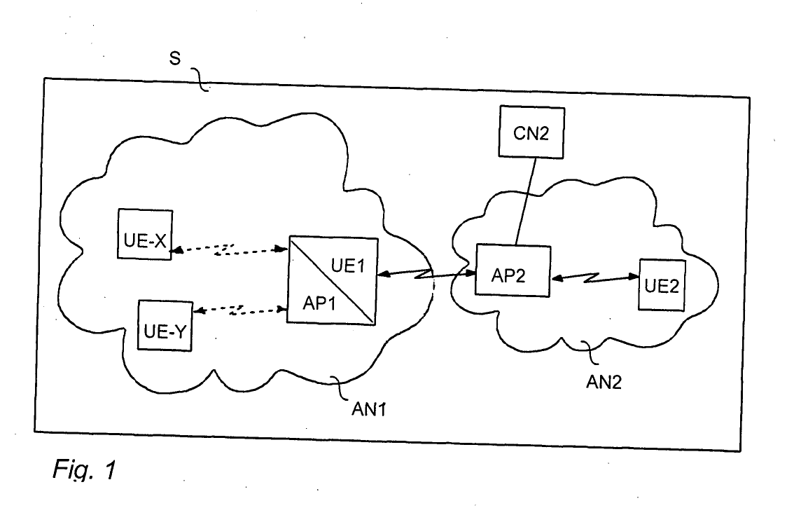

FIG. 1 illustrates a communications system S according to an embodiment of the present solution. FIG. 1 shows a simplified version of the network architecture, only illustrating components that are essential to the invention, even though those skilled in the art naturally know that a general wireless or mobile communications system also comprises other functions and structures, which do not have to be described in more detail herein. In FIG. 1, the telecommunications system S comprises two access networks AN1 and AN2. A first access network AN1 is, for example, a WLAN network, and it comprises a first access point AP1 with which user terminals UE-X and UE-Y within the coverage area of AP1 may communicate. A second access network AN2 comprises a second access point AP2 with which a user terminal UE2 within the coverage area of AP2 may communicate. The radio link between AP1 and UE-X, as well as a radio link between AP1 and UE-Y, is implemented by utilizing a first radio technology, such as WLAN. A radio link between AP1 and AP2, as well as a radio link between AP2 and UE2, is implemented as a backhaul link by utilizing a second radio technology, such as HSDPA, WiMAX or flash-OFDM. The second access point AP2 may be connected to a core network CN2 by utilizing a wired link, such as an optical fiber or a copper cable link. From the point of view of AP2, AP1 represents a user terminal UE1 capable of communicating with AP2 by utilizing the backhaul link between AP1 and AP2. The access points AP1, AP2 may also be referred to as base stations. It should be noted that in addition to AN1, also other access networks may or may not be served by the backhaul network AN2.

Thus, a first radio access network AN1 is provided, implemented with a first radio technology (e.g. WLAN), and a second radio access network AN2, implemented with a second radio technology (e.g. HSDPA). The second access network AN2 is used for end-user network access, as well as a backhaul link for the hot spot network, by means of the second radio technology. In a way, the hot spot base station AP1 resembles a user terminal UE1 connected to the second access network AN2.

In previous solutions, when considering a case where several users UE-X, UE-Y reside in the hot spot AP1, and one user terminal UE2 directly in the backhaul-providing network AN2, the resources of AP2 would not be evenly divided between the end-users UE-X, UE-Y, UE2. The two users UE-X, UE-Y in the hot spot AP1 would have to share an amount of resources similar to that received by the single user terminal UE2 in the second network AN2 alone.

In the present solution, a new functionality is added to the base station AP1 of the hot spot and to the base station AP2 of the backhaul network, which enables the resources to be divided evenly (or, if desired, according to operator needs). The hot spot base station AP1 is aware of the number of end-users UE-X, UE-Y currently residing within the hot spot AP1. The present solution is based on the idea that information on the number of user terminals UE-X, UE-Y currently connected to the hot spot AP1 is transmitted from the hot spot base station AP1 to an RRM (Radio Resource Management, not shown in the figures) functionality of the backhaul-providing network AN2. The RRM functionality may reside e.g. in the base station AP2 and/or in a radio network controller (not shown) of the backhaul network AN2. The RRM is then arranged to adopt the resource scheduling according to the number of end-users UE-X, UE-Y in the hot spot AP1 and, if desired, according to the number of end-users UE2 connecting directly through the backhaul network AN2.

The backhaul network resources may be allocated either on the basis of the number of user terminals UE-X, UE-X connected to AP1 only, or on the basis of the number of user terminals UE-X, UE-X connected to AP1 and the number of user terminals UE2 connected to AP2.

According to an embodiment, even scheduling is applied. In such a case, all the end-users UE-X, UE-Y, UE2 receive an equal amount of resources, i.e. the RRM calculates the total number of end-users in AN1 and AN2 cells and divides the total amount of resources evenly. Thus, in the situation shown in FIG. 1, the “logical” user terminal UE1 in the hotspot AP1 receives more resources than UE2, as the number of current users in AN1 is higher than the number of current users in AN2 (i.e. 2>1).

According to another embodiment, the hotspot AP1 is prioritised. In such a case, the RRM is arranged to provide more resources to the “logical” user terminal UE1 in the hotspot AP1. There may be a specific (e.g. operator-specific) reason for this, or the hotspot AP1 usage may be encouraged due to a better coverage and/or less interference that may be achieved.

According to yet another embodiment, direct users UE2 in the second network AN2 are prioritised. A reason to prioritise the user terminal UE2 directly connected through the backhaul network AN2 may be because the hotspot AP1 may be a secondary customer to the backhaul operator, or because the pricing may be different in direct AP2 access.

The present solution thus provides a resources allocation scheme that enables the resources to be evenly divided between the end-users UE-X, UE-Y in the hot spot AP1 and the end-users UE2 directly accessing the backhaul network AN2. If no even division is desired, the present solution also enables the resources to be divided, for example, according to the needs of the network operator.

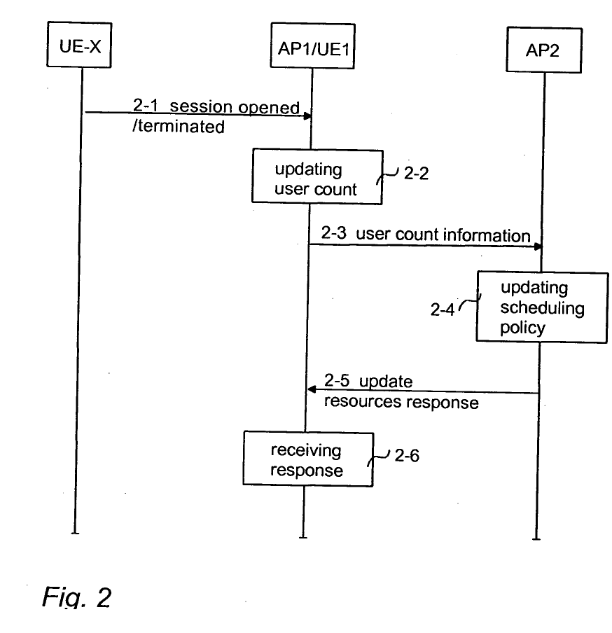

FIG. 2 illustrates signalling according to an embodiment of the present solution. At first, a user terminal UE-X connects 2-1 to a first access point AP1 (or alternatively disconnects from the AP1). Thus the number of user terminals served by AP1 changes, and this change is acknowledged in step 2-2 by the first access point AP1. Step 2-2 is carried out either by periodically requesting the number of users or on the basis of event-based reporting in the AP1. The event-based reporting refers to the AP1 recognizing if a user terminal starts or ends a session with AP1. Thus the first access point is able to update 2-2 the user count. Next, a change in the resources is requested by transmitting an update resources request message 2-3 from UE1 to an RRM functionality (which may be located in a second access point AP2 or some other network element in AN2). The message 2-3 may include information on the number of user terminals recently connected/disconnected to/from AP1, and/or information on the total number of user terminals in AP1. In step 2-4, an RRM algorithm calculates a new scheduling policy for user terminals/access points served by AP2, and AP2 starts to allocate the modified radio resources to UE1/AP1 and UE2. In a message 2-5, a response is transmitted to UE1/AP1, indicating that the requested resource update action has been carried out (or rejected if for some reason prohibited). In step 2-6, the response is received by AP1/UE1. The updated resources can now be utilized by the user terminals UE-X, UE-Y, UE2 (unless the update request was rejected).

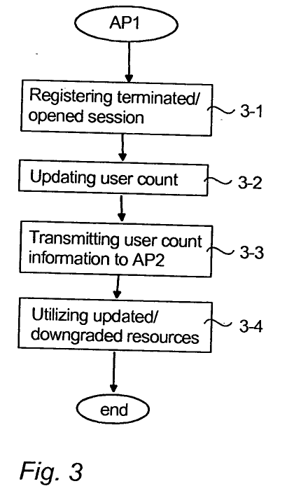

FIG. 3 illustrates the operation of a first access point AP1 located in a first access network AN1. In step 3-1, an opening/termination of a session between the access point AP1 and a user terminal UE-X, UE-Y is registered. Step 3-1 is carried out either by periodically requesting the number of users terminals or on the basis of event-based reporting. Thus a user count can be updated in step 3-2. Next, a change in resources is requested by transmitting 3-3 an update resources request message to the RRM functionality located in a second access point AP2 (or some other network element in AN2). The message may include information on the number of user terminals recently connected/disconnected to/from AP1, and/or information on the total number of user terminals in AP1. In step 3-4, a response is received in UE1/AP1, indicating that the requested resource update action has been carried out (or rejected if for some reason prohibited).

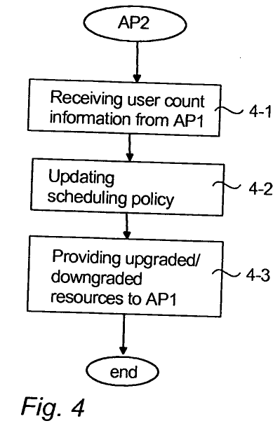

FIG. 4 illustrates the operation of a second access point AP2 located in a second access network AN2. In step 4-1, a resource update request message is received from AP1 UE1. The message may include information on the number of user terminals UE-X, UE-Y recently connected to/disconnected to/from AP1, and/or information on the total number of user terminals in AP1. In step 4-2, an RRM functionality (which may be located in the second access point AP2 or some other network element in AN2) calculates a new scheduling policy for user terminals/access points served by AP2, and AP2 starts to schedule the modified radio resources for UE1/AP1 and UE2. In step 4-3, a response is transmitted to UE1/AP1, indicating that the requested resource update action has been carried out (or rejected if for some reason prohibited).

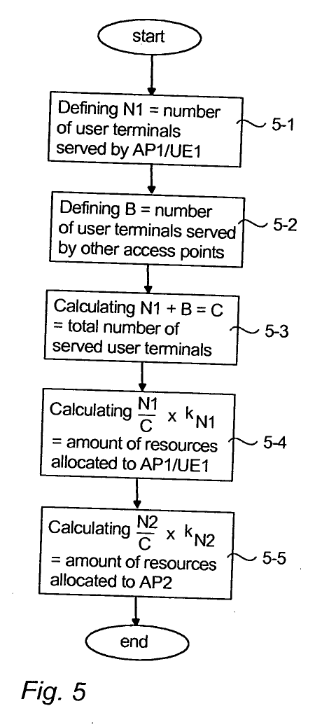

FIG. 5 illustrates, by way of example, a prioritisation scheme according to the present invention, by means of which AP2 is able to allocate resources in the network when prioritisation is applied. In step 5-11 of FIG. 5, the number of user terminals served by AP1/UE1 is defined as “N1” (based on the information received from AP1 as described above). The number of user terminals served by other access points in the network is defined in step 5-2 as “B”. The total number “C” of served user terminals in the network can thus be calculated in step 5-3 as follows: C=N1+B. The amount “R1” of resources allocated to the user terminal AP1/UE1 is calculated in step 64 as follows: R1=k_{N1}−N1/C, and the amount “R2” of resources allocated to the user terminal AP1/UE1 can be calculated in step 5-5 as follows: R2=k_{N2}·N2/C, wherein k_{N1} and k_{N2} represent weighting factors by means of which an operator is able to prioritise a respective selected access point AP1, AP2. Thus, by selecting a high value of the corresponding weighting factor, the operator is able to allocate more resources to the access point than suggested by the number of user terminals served by the access point.

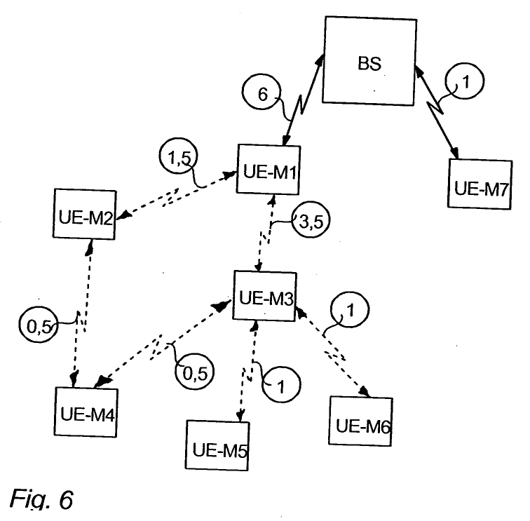

According to yet another embodiment, the present invention is applied to a mesh network where user terminals may also function as access points for other terminals. This embodiment enables the mesh network to be scheduled with a unified and fair mechanism. The embodiment is illustrated by way of a simplified example in FIG. 6 in which the functionality according to the embodiment is implemented in access points (i.e. in user terminals) UE-M1, UE-M2, UE-M3, UE-M4, UE-M5, UE-M6, UE-M7. The access point UE-M1, UE-M2, UE-M3 is arranged to report the number of respective active user terminals UE-M2, UE-M3, UE-M4, UE-M5, UE-M6 “below” it in the mesh network hierarchy to an access point BS, UE-M1, UE-M2, UE-M3 which is serving it. The base station BS represents an access point of the backhaul network. The number of active user terminals below the access point is determined on the basis of reports received from the terminals below. The number of user terminals is the actual number of active users in the whole network branch below the access point (+1, if the access point UE-M1, UE-M2, UE-M3 itself is active), not the number of terminals only directly below the access point. In a situation where user terminal is served by more than one access point, the reports can be divided between the respective access points such that resource fairness is restored. In the situation of FIG. 6, the user terminal UE-M4 is served by access points UE-M2, UE-M3. In such a case, no further user terminals exist in the hierarchy below UE-M4, but UE-M4 itself is active, so it should report to the access point serving it that the number of access points is 1. As there are two access points UE-M2, UE-M3 serving UE-M4, the value “1” is to be divided by two, i.e. ½=0.5. The numbers to be reported by the user terminals to the corresponding access points directly above them are shown in FIG. 6.

It should be noted that the RRM functionality and/or the functionality according to the present invention may be located in the hot spot access point and/or in the backhaul access point. On the other hand, the RRM functionality and/or the functionality according to the present invention may be located in a separate network element not shown in the figures (such as in a radio network controller or in an authentication centre, or even in a core network element).

It should be noted that the access point AP1/UE1 is able to obtain information on the number of user terminals UE-X, UE-Y connected to it. The access point AP2 of the backhaul network is able to obtain information on the number of user terminals UE2 connected to AP2.

It should also be noted that herein the term “connect” may also refer to a logical connection (a session) between the user terminal and the access point, although it is obvious to a person skilled in the art that the WLAN and HSDPA are based on a packet-switched data transmission utilizing connectionless protocols.

The items and steps shown in FIGS. 2, 3 and 4 are simplified, and only aim at describing the idea of the invention. Other items may be used and/or other functions may be carried out between the steps. The items only serve as examples and they may only contain some of the information mentioned above. The items may also include other information, and the titles may deviate from those given above. Instead of or in addition to an access point or a base station, the above described operations may be performed in any other element of a communications system.

In addition to prior art means, a system, networks or network nodes that implement the functionality of the invention comprise means for processing information relating to resource allocation in a manner described above. Existing network nodes and user terminals comprise processors and memory that can be utilized in the operations of the invention. Any changes necessary for implementing the invention may be carried out using supplements or updates of software routines and/or routines included in application specific integrated circuits (ASIC) and/or programmable circuits, such as EPLDs (Electrically Programmable Logic Device) or FPGAs (Field Programmable Gate Array).

It will be obvious to a person skilled in the art that as technology advances, the inventive concept can be implemented in various ways. The invention and its embodiments are not limited to the examples described above but may vary within the scope of the claims.

1-32. (canceled)

33. A method for allocating network resources in a communications system, the system comprising:
a first access point of a first wireless network utilizing a first radio technology, and
a second access point of a backhaul link-providing network utilizing a second radio technology, the second access point being capable of allocating resources of the backhaul link-providing network to the first access point and the second access point, wherein the method comprises:
obtaining, by the first access point, first information on the number of user terminals connected to the second access point via the first access point;
providing, by the first access point, said first information to the second access point; and
allocating, by the second access point, the resources the backhaul link-providing network to the first access point and to the second access point on the basis of said first information.

34. The method as claimed in claim 33, wherein the method comprises:
obtaining second information on the number of user terminals connected to the second access point; and
allocating the backhaul link-providing network resources to the first access point and the second access point on the basis of said first information and said second information.

35. The method as claimed in claim 33, wherein the method comprises:
checking, in the first access point, the number of user terminals connected to the first access point;
transmitting, from the first access point to the second access point, the first information on the number of user terminals communicating with the first access point;
receiving said first information in the second access point; and
dividing the backhaul link-providing network resources between the user terminals on the basis of said information.

36. The method as claimed in claim 33, wherein the method comprises updating the information on the number of user terminals connected to the first access point as a response to detecting a predetermined event in the first access network.

37. The method as claimed in claim 36, wherein the predefined event comprises a termination of a session between the first access point and at least one user terminal.

38. The method as claimed in claim 36, wherein the predefined event comprises an opening of a session between the first access point and at least one user terminal.

39. The method as claimed in claim 33, wherein the method comprises updating the information on the number of user terminals connected to the first access point at predetermined time intervals.

40. The method as claimed in claim 33, wherein the method comprises allocating the backhaul link-providing network resources equally between the user terminals connected to the first access point and the user terminals connected to the second access point.

41. The method as claimed in claim 33, wherein the method comprises allocating the backhaul link-providing network resources such that one or more user terminals connected to the first access point are prioritised.

42. The method as claimed in claim 33, wherein the method comprises allocating the backhaul link-providing network resources such that one or more user terminals connected to the second access point are prioritised.

43. The method as claimed in claim 33, wherein the amount of backhaul link-providing network resources allocated to the access point is proportional to a respective weighting factor.

44. The method as claimed in claim 33, wherein the method comprises allocating the backhaul link-providing network resources to the user terminal connected to the first access point on the basis of a predefined contract between a network operator and a subscriber.

45. The method as claimed in claim 33, wherein the first access network comprises a mesh network, wherein the method comprises:
providing, from a lower-hierarchy user terminal, to at least one upper-hierarchy user terminal, information on the number of active user terminals below the lower-hierarchy user terminal in the mesh network hierarchy; and
allocating the backhaul link-providing network resources to the mesh network on the basis of the total number of active user terminals in the mesh network.

46. The method as claimed in claim 33, wherein the first access network comprises a Wireless Local Area Network.

47. The method as claimed in claim 33, wherein the backhaul link-providing network utilizes High-speed Downlink Packet Access, Worldwide Interoperability for Microwave Access, and/or flash-Orthogonal Frequency Division Multiplexing, flash-OFDM.

48. A communications system comprising:
a first access point of a wireless network utilizing a first radio technology, and a second access point of a backhaul link-providing network utilizing a second radio technology, wherein the second access point is capable of allocating resources of the backhaul link-providing network to the first access point and to the second access point, wherein the system is configured to:
obtain, by the first access point, information on the number of user terminals connected to the second access point via the first access point;
provide, by the first access point, said information to the second access point; and
allocate, by the second access point, the resources the backhaul link-providing network resources to the first access point and to the second access point on the basis of the number of user terminals connected to the first access point.

49. The system as claimed in claim 48, wherein it is configured to allocate the backhaul link-providing network resources to the first access point and to the second access point on the basis of the number of user terminals connected to the first access point as well as the number of user terminals connected to the second access point.

50. The system as claimed in claim 48, wherein the first access point is arranged to:
check the number of user terminals communicating with the first access point; and
transmit, to the second access point, information on the number of user terminals communicating with the first access point;
wherein the second access point is arranged to
receive said information; and
divide the backhaul link-providing network resources between the user terminals based on said information.

51. The system as claimed in claim 48, wherein it is configured to update the information on the number of user terminals connected to the first access point as a response to detecting a predefined event in the first access network.

52. The system as claimed in claim 51, wherein the predefined event comprises a termination of a session between the first access point and at least one user terminal.

53. The system as claimed in claim 51, wherein the predefined event comprises an opening of a session between the first access point and at least one user terminal.

54. The system as claimed in claim 48, wherein it is configured to update the information on the number of user terminals connected to the first access point at predetermined time intervals.

55. The system as claimed in claim 48, wherein it is configured to allocate the backhaul link-providing network resources equally between the user terminals connected to the first access point and the user terminals connected to the second access point.

56. The system as claimed in claim 48, wherein it is configured to allocate the backhaul link-providing network resources such that one or more user terminals connected to the first access point are prioritized.

57. The system as claimed in claim 48, wherein it is configured to allocate the backhaul link-providing network resources such that one or more user terminals connected to the second access point are prioritised.

58. The system as claimed in claim 48, wherein it is configured to allocate the backhaul link-providing network resources to the access point such that the amount of allocated resources is proportional to a respective weighting factor.

59. The system as claimed in claim 48, wherein it is configured to allocate the backhaul link-providing network resources to the user terminal connected to the first access point on the basis of a predefined contract between a network operator and a subscriber.

60. The system as claimed in claim 48, wherein the first access network comprises a mesh network, wherein the system is configured to:
provide, from a lower-hierarchy user terminal, to at least one upper-hierarchy user terminal, information on the number of active user terminals below the lower-hierarchy user terminal in the mesh network hierarchy; and
allocate the backhaul link-providing network resources to the mesh network on the basis of the total number of active user terminals in the mesh network.

61. The system as claimed in claim 48, wherein the first access network comprises a Wireless Local Area Network.

62. The system as claimed in claim 48, wherein the backhaul link-providing network is arranged to utilize High-speed Downlink Packet Access, Worldwide Interoperability for Microwave Access, and/or flash-Orthogonal Frequency Division Multiplexing, flash-OFDM.

63. An access point for a wireless access network utilizing a first radio technology, wherein it is configured to:
obtain information on the number of user terminals connected to it; and
provide said information to a second access point of a backhaul link-providing network utilizing a second radio technology.

64. An access point of a backhaul link-providing network, wherein it is configured to:
receive first information on the number of user terminals connected to an access point of a wireless access network other than the backhaul link-providing network; and
allocate resources of the backhaul link-providing network to the access point of the wireless access network and to the access point of the backhaul link-providing network on the basis of the first information.
